(19) United States
(12) Patent Application Publication
(10) Pub. No.: US 2025/0382986 A1
(43) Pub. Date: Dec. 18, 2025

(54) FIXING DEVICE

(71) Applicant: HANWIT PRECISION INDUSTRIES LTD., New Taipei City (TW)

(72) Inventors: Ying-Chih TSENG, New Taipei City (TW); Ming-De WU, New Taipei City (TW); Ching-Kai CHANG, New Taipei City (TW)

(21) Appl. No.: 18/743,849

(22) Filed: Jun. 14, 2024

(51) Int. Cl. F16B 19/10; F16B 13/06

(52) U.S. Cl. CPC F16B 19/1054; F16B 13/061

(57) ABSTRACT

A fixing device includes a base, a sleeve mounted in the base, a fixing member mounted in the sleeve, an elastic member set between the outside of a shank and the sleeve, and a cap capped on the top of the fixing member. When the pulling portion of the base is driven to rotate in a first direction, the resisting position of the resisting portion of the base is moved from a first positioning area of the cap to a second positioning area via a guide ramp, and the cap and the fixing member are moved upward to become unlocked. When the pulling portion is driven to rotate in a second direction, the resisting position of the resisting portion is moved from the second positioning area to the first positioning area via the guide ramp, and the cap and the fixing member are moved downward to become locked.

### BACKGROUND OF THE INVENTION

### 1. Field of the Invention

The present invention provides a fixing device, especially the sleeve of the fixing device is riveted to the first plate member through the bottom fixing flange. When the pulling portion is driven to rotate in a first direction, the resisting position of the resisting portion is moved from the first positioning area to the second positioning area via the guide ramp, and the cap and the fixing member are moved upward to break away from the second through hole of the second plate member and enter the unlocked state. When the pulling portion is driven to rotate in an opposing second direction, the resisting position of the resisting portion is moved from the second positioning area to the first positioning area via the guide ramp, and the cap and the fixing member are moved downward to extend into the second through hole of the second plate member and enter the locked state. The plurality of limiting grooves provided on the sleeve can serve as a resistance limiter for the plurality of positioning blocks of the base and make the positioning clear, so that it has a segmented feel when rotating and is not easy to over-rotate or under-rotate. And the plurality of limiting grooves and the plurality of positioning blocks serve as a support to ensure that the fixing device maintains stable rotation during the locking and unlocking process.

### 2. Description of the Related Art

When general panels (board-to-board) are assembled, they are locked using positioning screws equipped with knobs, collars and screws, and the screws and collars can be fixed to the first panel, and apply force to turn the knob so that the screws can be locked into the second panel to form a predetermined position. Then use a hand tool to lock the screws, so that the first panel and the second panel are locked and fixed into one. This locking method can be used in telecommunications office cabinets, industrial computer cases, workstation panels, etc., by using a plurality of knobs, screws and other devices and mechanisms for board-to-board connection.

However, if the user or field worker does not carry appropriate hand tools when working, the overall disassembly and assembly work will be affected. Therefore, some manufacturers have developed another positioning device that can be used by field workers or users to rotate with bare hands to fix or disassemble board-to-board assembly. Please refer to FIGS. 8 and 9. It can be clearly seen from the figures that the conventional positioning device is provided with a through-hole A1 inside the sleeve A, and a limiting ring A2 is protruding from the outer edge of the top of the sleeve A. The surface of the limiting ring A2 is provided with a plurality of grooves A21 arranged at intervals. The limiting ring A2 forms two first ring edges A22 of enlarged outer diameter between any two adjacent grooves A21, and two second ring edges A23 of reduced outer diameter staggered with the two first ring edges A22. Then penetrate the shank B1 of a rotary locking member B in the through hole A1. The bottom of shank B1 is equipped with a rotary rod B2. There is also a shank head B3 on the top of shank B1 that exposes the outside of sleeve A. The shank B1 is sleeved with an elastic member B4 that resists the inside of the through hole A1, and the rotary locking member B is assembled with an outer sleeve C on the outside. There is an installation space C1 inside the outer sleeve C for assembly of the shank head B3. One side of the installation space C1 is provided with a sliding hole C2 that covers the outside of the limiting ring A2 and moves longitudinally.

There are two opposite long protrusions C21 and two opposite short protrusions C22 adjacent to the two long protrusions C21 on the inner wall of the sliding hole C2. Each long protrusion C21 and short protrusion C22 are respectively aligned and locked in each groove A21 on the outer edge of the limiting ring A2. The outer top of the outer sleeve C is provided with an angular twisting portion C3 facing outward. There is also an indicator C4 with opening and closing marks on the top surface of outer sleeve C. When the sleeve A is positioned on the preset positioning plate (not shown in the figures), the outer sleeve C can be used to drive the shank B1 of the rotary locking member B to perform longitudinal lifting and lowering displacement along the through hole A1 of the sleeve A, making the rotary rod B2 of the rotary locking member B pass through the hole in the preset fixed plate member (not shown in the figures). Then rotate the outer sleeve C by turning the angular twisting portion C3 of the outer sleeve C 90 degrees clockwise or counterclockwise, thereby driving the rotary rod B2 to rotate and hold on the bottom surface of the preset fixed plate member. Then, the preset positioning plate member and the preset fixed plate member can be locked together with bare hands.

However, since the two first ring edges A22 and the two second ring edges A23 of the limiting ring A2 of the sleeve A are arranged in a staggered manner, and the long protrusions C21 and short protrusions C22 of the inner wall of the sliding hole C2 of the outer sleeve C are arranged oppositely, when the outer sleeve Cis pressed down and rotated, the two long protrusions C21 of the outer sleeve C can only rotate in the direction of the two second ring edges A23 with the smaller outer diameter at the same time. Therefore, whether the outer sleeve C is in the locked or unlocked state, it can only be used by reciprocating rotation in one direction (clockwise or counterclockwise). As a result, when the rotation rod B2 of the rotary locking member B is locked on the preset fixed plate member, subsequent users cannot know whether the rotary locking member B is locked or unlocked by rotating it (because locking or unlocking both rotate 90 degrees). This will affect the time and smoothness of the overall disassembly and assembly work. Not only is it quite time-consuming and inconvenient, but also the indicator C4 must be further processed on the top surface of the outer sleeve C to know the locking and unlocking direction of the positioning device, thereby increasing the cost of the processing operation. Whether the outer sleeve C is in the locked or unlocked state, it is used by reciprocating rotation. The long protrusions C21 and the short protrusions C22 of the outer sleeve C are rotated at the limiting ring A2. It is easy to operate the outer sleeve C with too much force or too fast, causing the long protrusions C21 and the short protrusions C22 to cross the groove A21 to be locked and rotate to the groove A21 of the next position. Improper conditions that lead to inaccurate locking can also easily lead to friction losses between the long protrusions C21 and the short protrusions C22, the grooves A21, the two first ring edges A22 and the two second ring edges A23.

Therefore, how to solve the problem that when applying force to rotate the outer sleeve, it is easy to cause troubles and defects such as rotating beyond the positioned position due to excessive force, that is the direction that relevant manufacturers in this industry are eager to study and improve.

### SUMMARY OF THE INVENTION

Therefore, in view of the above-mentioned problems and deficiencies, the inventor collected relevant information, and after multiple evaluations and considerations, he designed the invention of this fixing device.

The main object of the present invention is to provide a fixing device, which comprises a base, a sleeve, a fixing member, an elastic member, and a cap. The base comprises a main body, a storage cavity defined in the main body, a plurality of positioning blocks embossed on the surface of the storage cavity, at least one resisting portion formed on the main body at a relatively higher position, at least one accommodating portion formed on the main body at a relatively lower position, and a pulling portion extended outward from the resisting portion. The sleeve comprises a sleeve body passed through the storage cavity, a channel formed inside the sleeve body, an outwardly protruding stop ring body formed on a bottom side of the sleeve body, a plurality of limiting grooves located on the stop ring body for the positioning blocks to resist and position respectively, and a fixing flange extended downward from a bottom side of the stop ring body. The fixing member comprises a shank passed through the channel, a connecting portion locate on a top end of the shank, and a latch body expanded outward at an opposing bottom end of the shank. The elastic member is mounted between the outside of the shank and the sleeve. The cap comprises a cap body, a receiving chamber formed inside the cap body, an engaging groove downwardly connected with the receiving chamber for the connecting portion of the fixing member to be fastened, and a first positioning area, a guide ramp and a second positioning area formed on a bottom side of the cap body for the resisting portion and the accommodating portion of the base to contact and accommodate. The sleeve of the fixing device is riveted to the first plate member through the bottom fixing flange, When the pulling portion is driven to rotate in a first direction, the resisting position of the resisting portion is moved from the first positioning area to the second positioning area via the guide ramp, and the cap and the fixing member are moved upward to break away from the second through hole of the second plate member and enter the unlocked state. When the pulling portion is driven to rotate in an opposing second direction, the resisting position of the resisting portion is moved from the second positioning area to the first positioning area via the guide ramp, and the cap and the fixing member are moved downward to extend into the second through hole of the second plate member and enter the locked state. The plurality of limiting grooves provided on the sleeve can serve as a resistance limiter for the plurality of positioning blocks of the base and make the positioning clear, so that it has a segmented feel when rotating and is not easy to over-rotate or under-rotate. And the plurality of limiting grooves and the plurality of positioning blocks serve as a support to ensure that the fixing device maintains stable rotation during the locking and unlocking process.

Another object of the present invention is that the appearance of the pulling portion of the base is similar to a hollow semicircular body, and the volume of the pulling portion is larger than the main body.

Still another object of the present invention is that the sleeve further comprises a plurality of arc-shaped tops located at the top side of the sleeve body, and a limited plane formed at an inner wall of each top; the shank of the fixing member is cut to form a plurality of positioning surfaces corresponding to the limited planes.

Still another object of the present invention is that the cap further comprises a metal fixing flange installed at the center of the top surface thereof through an insert molding process, and the engaging groove is formed in the metal fixing flange of the cap.

Still another object of the present invention is that the base comprises two positioning blocks embossed on the surface of the storage cavity at an angle of ninety degrees apart, and the sleeve comprises three limiting grooves arranged on the stop ring body at an angle of ninety degrees apart corresponding to the two positioning blocks, so that when in a one-way rotation, the number of the limiting grooves is equal to the number of the positioning blocks plus one, and when in a two-way rotation, the number of the limiting grooves is equal to the number of the positioning blocks plus two.

### BRIEF DESCRIPTION OF THE DRAWINGS

FIG. 1 is a three-dimensional appearance view of the fixing device of the present invention in a locked state.

FIG. 2 is an exploded three-dimensional view of the fixing device of the present invention.

FIG. 3 is an exploded three-dimensional view of the fixing device of the present invention from another perspective.

FIG. 4 is a side cross-sectional view of the fixing device of the present invention in a locked state.

FIG. 5 is a side cross-sectional view of the fixing device of the present invention in an unlocked state.

FIG. 6 is a top cross-sectional view of the fixing device of the present invention in the locked to unlocked state.

FIG. 7 is a three-dimensional appearance view of the fixing device of the present invention in an unlocked state.

FIG. 8 is a three-dimensional exploded view of a conventional positioning device.

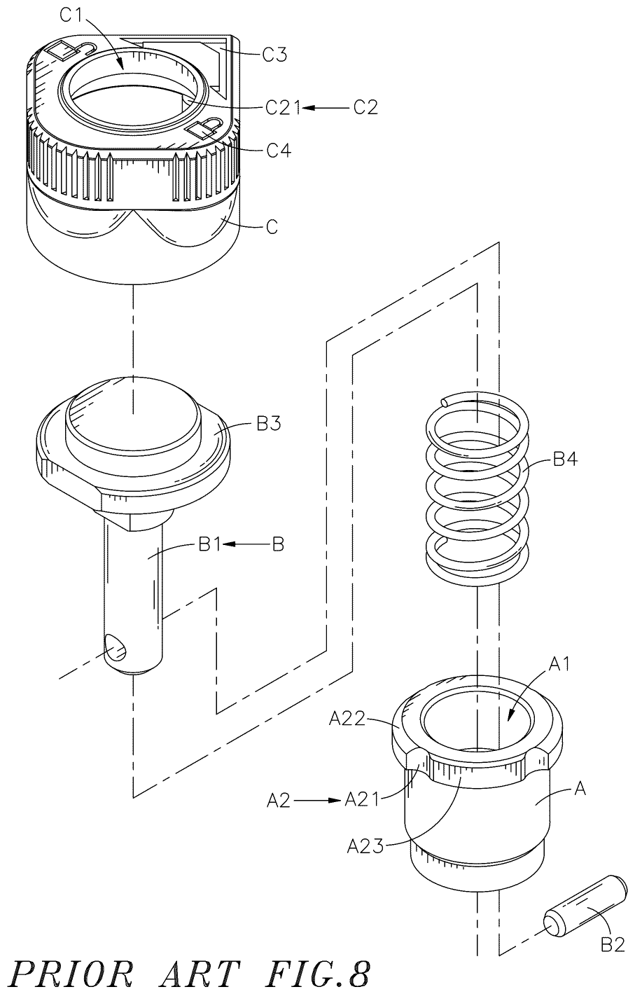

FIG. 9 is a three-dimensional exploded view of the conventional positioning device from another perspective.

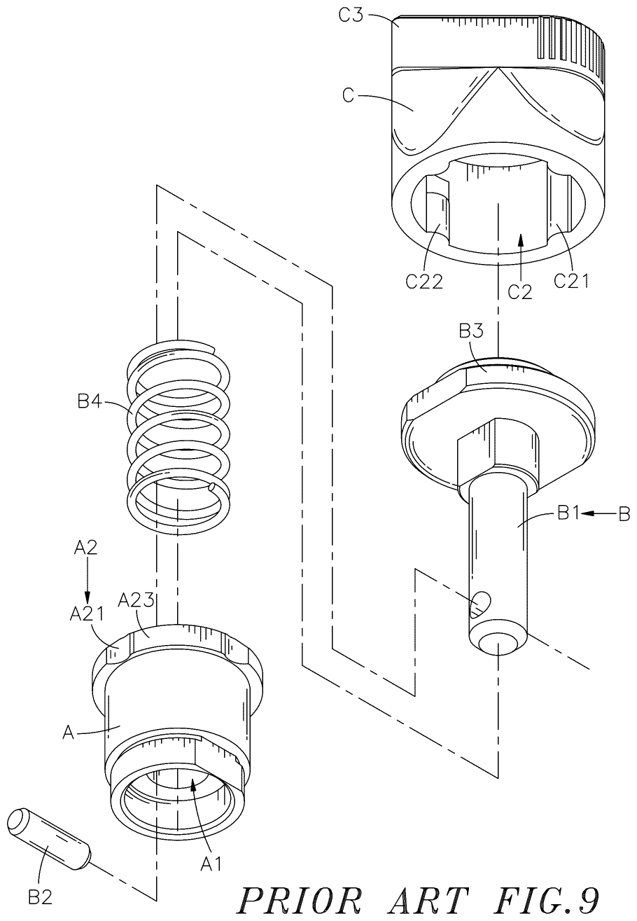

### DETAILED DESCRIPTION OF THE PREFERRED EMBODIMENT

In order to achieve the above objects and effects, the technical means and structures adopted by the present invention are described in detail below by way of a preferred embodiment accompanying with the annexed drawings so as to facilitate a complete understanding.

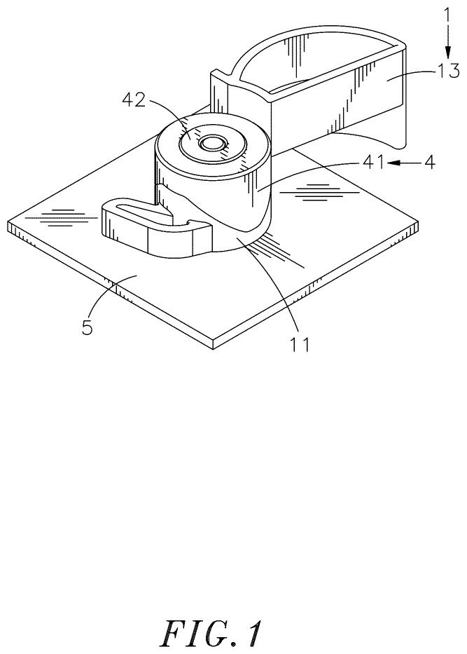

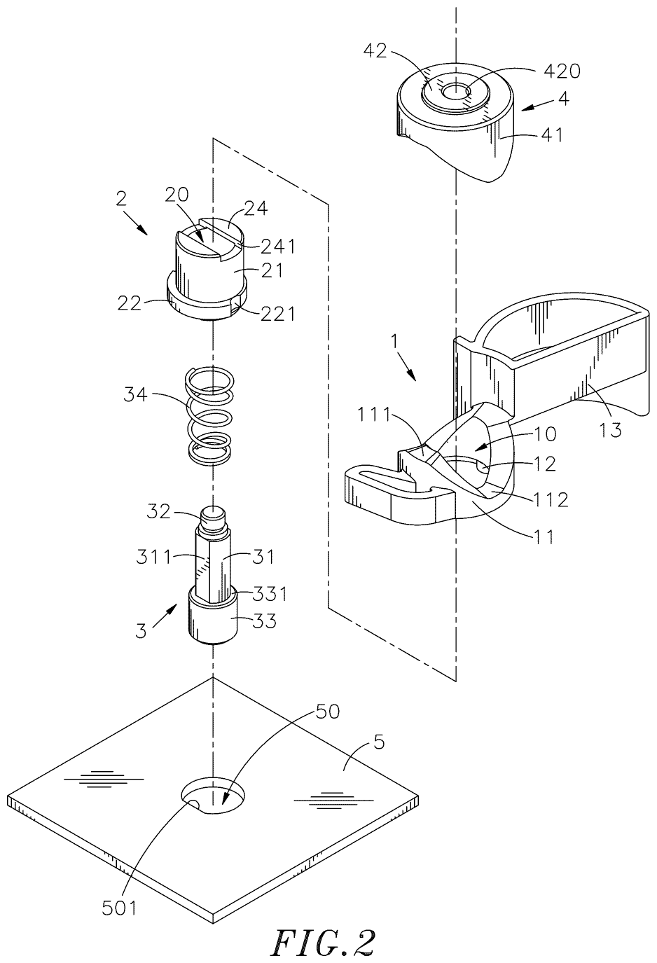

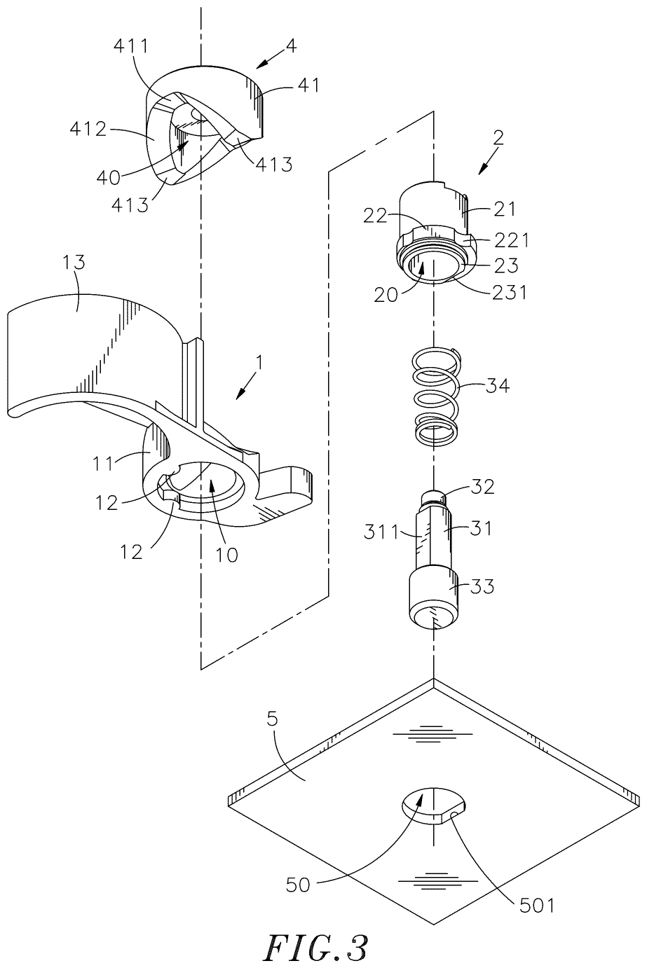

Please refer to FIGS. 1-3, which are three-dimensional appearance view of the fixing device of the present invention in a locked state, exploded three-dimensional view of the fixing device of the present invention and exploded three-dimensional view of the fixing device of the present invention from another perspective. It can be clearly seen from the figures that the fixing device of the present invention comprises a base 1, a sleeve 2, a fixing member 3, an elastic member 34 and a cap 4. Its main components and features are detailed as follows:

The base 1 comprises a main body 11, a storage cavity 10 defined in the main body 11, a plurality of positioning blocks 12 embossed on the surface of the storage cavity 10, at least one resisting portion 111 formed on the main body 11 at a higher position, at least one accommodating portion 112 formed on the main body 11 at a lower position, and a pulling portion 13 extended outward from the resisting portion 111.

The sleeve 2 comprises a sleeve body 21 passed through the storage cavity 10, a channel 20 formed inside the sleeve body 21, an outwardly protruding stop ring body 22 formed on the bottom side of the sleeve body 21, a plurality of limiting grooves 221 located on the stop ring body 22 for the positioning blocks 12 to resist and position respectively, and a fixing flange 23 extended downward from the bottom side of the stop ring body 22.

The fixing member 3 comprises a shank 31 passed through the channel 20, a connecting portion 32 locate on the top end of the shank 31, and a latch body 33 expanded outward at the opposing bottom end of the shank 31.

The elastic member 34 is mounted between the outside of the shank 31 and the sleeve 2. The elastic member 34 is composed of a spring.

The cap 4 comprises a cap body 41, a receiving chamber 40 formed inside the cap body 41, an engaging groove 420 downwardly connected with the receiving chamber 40 for the connecting portion 32 of the fixing member 3 to be fastened, a first positioning area 411, a guide ramp 412 and a second positioning area 413 formed on the bottom side of the cap body 41 for the resisting portion 111 and the accommodating portion 112 of the base 1 to contact and accommodate. When the pulling portion 13 is driven to rotate in a first direction, the resisting position of the resisting portion 111 can be moved from the first positioning area 411 to the second positioning area 413 via the guide ramp 412, and the cap 4 and the fixing member 3 are moved upward to become unlocked. When the pulling portion 13 is driven to rotate in a second direction, the resisting position of the resisting portion 111 can be moved from the second positioning area 413 to the first positioning area 411 via the guide ramp 412, and the cap 4 and the fixing member 3 are moved downward to become locked.

The appearance of the pulling portion 13 of the above-mentioned base 1 is similar to a hollow semicircular body, and the volume of the pulling portion 13 is larger than that of the main body 11. Through the structure of the larger pulling portion 13, a longer moment is formed and the force is easily applied.

The surface of the storage cavity 10 of the above-mentioned base 1 is formed with two positioning blocks 12 at an angle of ninety degrees apart. The stop ring body 22 of the sleeve 2 is provided with three limiting grooves 221 at an angle of ninety degrees apart corresponding to the two positioning blocks 12. If it is one-way rotation, the number of the limiting grooves 221 is equal to the number of the positioning blocks 12 plus one. In the case of two-way rotation, the number of the limiting grooves 221 is equal to the number of the positioning blocks 12 plus two.

The top side of the sleeve body 21 of the sleeve 2 is formed with a plurality of arc-shaped tops 24, and limited planes 241 are formed at the opposite inner walls of the tops 24. The shank 31 of the fixing member 3 is cut to form positioning surfaces 311 corresponding to the limited planes 241. Through the aforementioned structure, the fixing member 3 will not rotate relative to the sleeve 2. An anti-rotation cut edge 231 is formed on the outer wall of the fixing flange 23 of the sleeve 2, and the first through hole 50 of the first plate member 5 is preset to have a limiting edge 501 corresponding to the anti-rotation cut edge 231. Through the aforementioned structure, the sleeve 2 will not rotate relative to the first plate member 5.

A shoulder 331 for one end of the elastic member 34 to resist and position is formed between the shank 31 of the fixing member 3 and the latch body 33, and the other end of the elastic member 34 resists and positions the bottom surface of the tops 24 of the sleeve 2. The diameter of the latch body 33 of the fixing member 3 is larger than that of the shank 31, and the diameter of the shank 31 is larger than that of the connecting portion 32.

A fixing flange 42 made of metal is installed at the center of the top surface of the cap 4 through an insert molding process, and the engaging groove 420 is formed in the fixing flange 42.

When assembling the fixing device of the present invention, first place the elastic member 34 onto the shank 31 of the fixing member 3 to stop one end of the elastic member 34 against the shoulder 331. Then insert the connecting portion 32 of the fixing member 3 into the channel 20 in the sleeve 2 from bottom to top to make the positioning surfaces 311 of the shank 31 pair with the limited planes 241 of the sleeve 2, and to expose the connecting portion 32 of the fixing member 3 above the tops 24 of the sleeve 2 to form a pre-positioning. At the same time, the other end of the elastic member 34 resists the bottom surface of the tops 24 of the sleeve 2. Continue to insert the sleeve 2 into the storage cavity 10 of the base 1 from bottom to top, and make the limiting grooves 221 of the sleeve 2 contact and position the positioning blocks 12 of the base 1. Finally, the engaging groove 420 of the cap 4 is attached onto the connecting portion 32 of the fixing member 3 from top to bottom to make the first positioning area 411 of the cap 4 come into contact with the resisting portion 111 of the base 1, and the second positioning area 413 come into contact with the accommodating portion 112. Thus, the tight joint structure of the main body 11 of the base 1 and the cap 4 is formed, and the assembly of the fixing device is completed by the above.

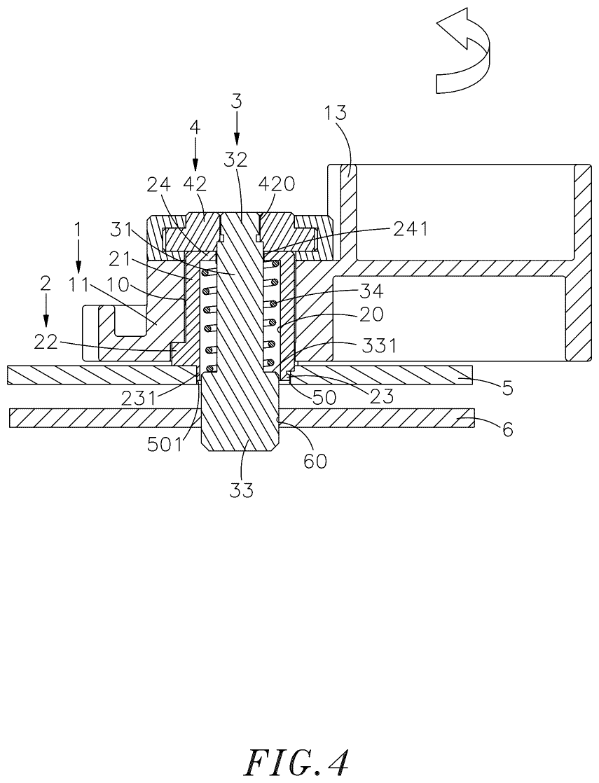

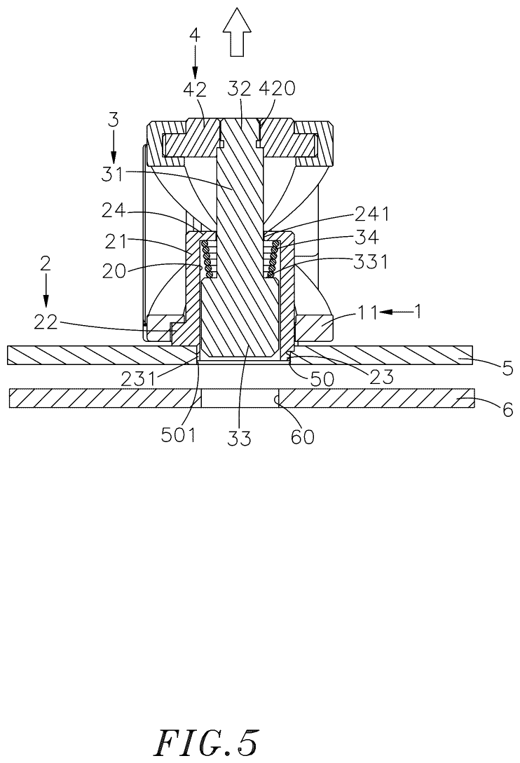

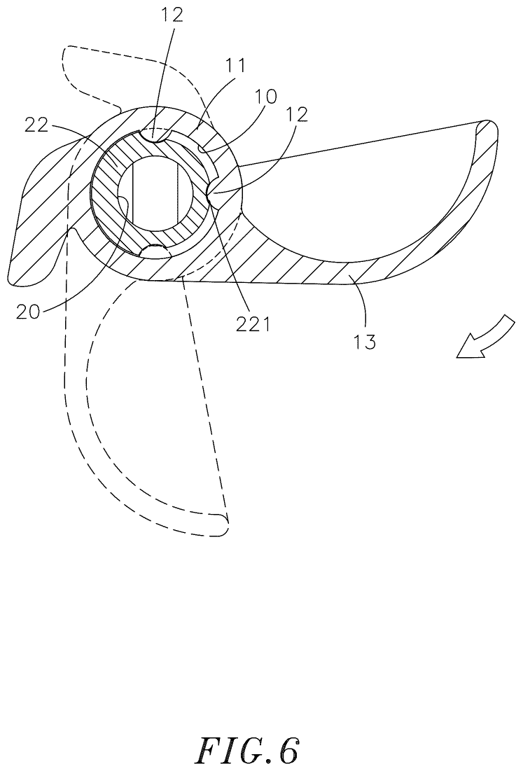

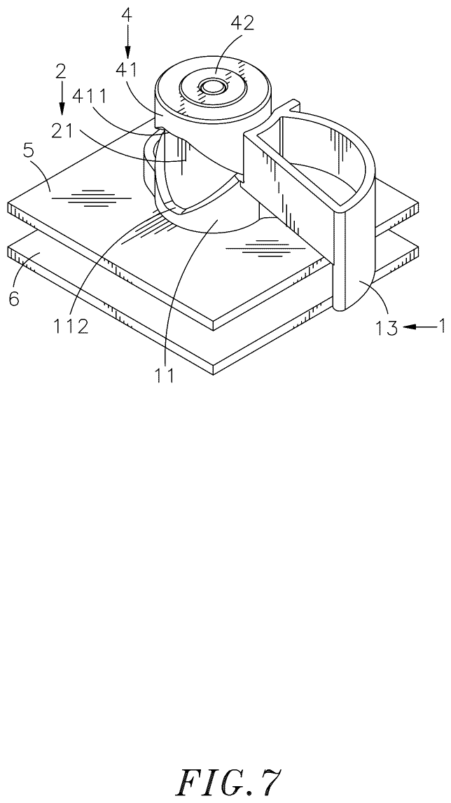

Please refer to FIGS. 4-7, which are side cross-sectional view of the fixing device of the present invention in a locked state, side cross-sectional view of the fixing device of the present invention in an unlocked state, top cross-sectional view of the fixing device of the present invention in the locked to unlocked state and three-dimensional appearance view of the fixing device of the present invention in an unlocked state. Please also refer to the disclosure in FIG. 1. When the fixing device is actually used to fix two plate members, first insert the fixing flange 23 on the bottom side of the sleeve 2 into the first through hole 50 of the first plate member 5 to correspond the anti-rotation cut edge 231 on the side of the fixing flange 23 to the limiting edge 501 in the first through hole 50, the fixing device is punched and riveted from top to bottom through the punching jig to form a fixation on the first plate member 5. Then, the fixing device is punched and riveted from top to bottom through the stamping jig to the first plate member 5 to form a fixation. When the pulling portion 13 of the base 1 is driven to rotate ninety degrees in the first direction, the resisting position of the resisting portion 111 can be moved from the first positioning area 411 to the second positioning area 413 via the guide ramp 412, and the cap 4 and the fixing member 3 can be moved upward to break away from the second through hole 60 of the second plate member 6 and enter the unlocked state. At the same time, the two positioning blocks 12 of the base 1 are moved along the outer edge of the stop ring body 22 of the sleeve 2 to the respective adjacent limiting grooves 221 to form positioning. When the pulling portion 13 of the base 1 is driven to rotate ninety degrees in the second direction, the resisting position of the resisting portion 111 can be moved from the second positioning area 413 to the first positioning area 411 via the guide ramp 412, and the cap 4 and the fixing member 3 are moved downward to extend into the second through hole 60 of the second plate member 6 and enter the locked state. At the same time, the two positioning blocks 12 of the base 1 move along the outer edge of the stop ring body 22 of the sleeve 2 and return to the respective original limiting grooves 221 to form positioning. The advantage of the aforementioned structure is that the plurality of limiting grooves 221 provided on the sleeve 2 can serve as a resistance limiter for the plurality of positioning blocks 12 of the base 1 and make the positioning clear, so that it has a segmented feel when rotating and is not easy to over-rotate or under-rotate. And the plurality of limiting grooves 221 and the plurality of positioning blocks 12 serve as a support to ensure that the fixing device maintains stable rotation during the locking and unlocking process.

The above description is only a preferred embodiment of the present invention, and does not limit the patent scope of the present invention. Therefore, all simple modifications and equivalent structural changes made by using the contents of the description and drawings of the present invention shall be included in the patent scope of the present invention and shall be clearly stated.

To sum up, the above-mentioned fixing device of the present invention can indeed achieve its effect and purpose when actually used. Therefore, this invention is truly an invention with excellent practicality. In order to meet the application requirements for an invention patent, I file the application in accordance with the law. I hope that the Review Committee will approve this case as soon as possible to protect the inventor's hard work. If the Review Committee has any doubts, please feel free to send us a letter for instructions. The inventor will try our best to cooperate. We sincerely appreciate it.

What the invention claimed is:

1. A fixing device, comprising:
a base comprising a main body, a storage cavity defined in said main body, a plurality of positioning blocks embossed on a surface of said storage cavity, at least one resisting portion formed on said main body at a relatively higher position, at least one accommodating portion formed on said main body at a relatively lower position, and a pulling portion extended outward from said resisting portion;
a sleeve comprising a sleeve body passed through said storage cavity, a channel formed inside said sleeve body, an outwardly protruding stop ring body formed on a bottom side of said sleeve body, a plurality of limiting grooves located on said stop ring body for said positioning blocks to resist and position respectively, and a fixing flange extended downward from a bottom side of said stop ring body;
a fixing member comprising a shank passed through said channel, a connecting portion locate on a top end of said shank, and a latch body expanded outward at an opposing bottom end of said shank;
an elastic member mounted between an outside of said shank and said sleeve; and
a cap comprising a cap body, a receiving chamber formed inside said cap body, an engaging groove downwardly connected with said receiving chamber for said connecting portion of said fixing member to be fastened, and a first positioning area, a guide ramp and a second positioning area formed on a bottom side of said cap body for said resisting portion and said accommodating portion of said base to contact and accommodate;
wherein when said pulling portion is driven to rotate in a first direction, a resisting position of said resisting portion is moved from said first positioning area to said second positioning area via said guide ramp, and said cap and said fixing member are moved upward to become unlocked; when said pulling portion is driven to rotate in an opposing second direction, a resisting position of said resisting portion is moved from said second positioning area to said first positioning area via said guide ramp, and said cap and said fixing member are moved downward to become locked.

2. The fixing device as claimed in claim 1, wherein an appearance of said pulling portion of said base is a hollow semicircular body, and a volume of said pulling portion is larger than said main body.

3. The fixing device as claimed in claim 1, wherein said sleeve further comprises a plurality of arc-shaped tops located at a top side of said sleeve body, and a limited plane formed at an inner wall of each said top; said shank of said fixing member is cut to form a plurality of positioning surfaces corresponding to said limited planes.

4. The fixing device as claimed in claim 1, wherein said sleeve further comprises an anti-rotation cut edge located on an outer wall of said fixing flange of said sleeve corresponding to a limiting edge in a first through hole of a preset first plate member.

5. The fixing device as claimed in claim 1, wherein said elastic member is a spring.

6. The fixing device as claimed in claim 1, wherein said fixing member further comprises a shoulder formed between said shank and said latch body; said elastic member has one end thereof stopped against said shoulder and an opposite end thereof stopped against at a bottom side of said tops of said sleeve.

7. The fixing device as claimed in claim 1, wherein a diameter of said latch body of said fixing member is larger than that of said shank, and a diameter of said shank is larger than that of said connecting portion.

8. The fixing device as claimed in claim 1, wherein said cap further comprises a metal fixing flange installed at a center of a top surface thereof through an insert molding process, and said engaging groove is formed in said metal fixing flange of said cap.

9. The fixing device as claimed in claim 1, wherein said base comprises two said positioning blocks embossed on said surface of said storage cavity at an angle of ninety degrees apart, and said sleeve comprises three said limiting grooves arranged on said stop ring body at an angle of ninety degrees apart corresponding to said two positioning blocks, so that when in a one-way rotation, the number of said limiting grooves is equal to the number of said positioning blocks plus one, and when in a two-way rotation, the number of said limiting grooves is equal to the number of said positioning blocks plus two.
